(19) United States
(12) Patent Application Publication
(10) Pub. No.: US 2005/0227188 A1
(43) Pub. Date: Oct. 13, 2005

(54) Silver halide photosensitive material and method of forming image

(76) Inventors: Toyoki Nishijima, Hino-shi (JP); Hirokazu Sato, Hino-shi (JP)

Correspondence Address: FRISHAUF, HOLTZ, GOODMAN & CHICK, PC, 220 5TH AVE FL 16, NEW YORK, NY, 10001-7708, US

(21) Appl. No.: 10/521,229

(22) PCT Filed: Jul. 18, 2002
(86) PCT No.: PCT/JP02/07311

§ 371 Date: Jan. 13, 2005

(51) Int. Cl. G03C 5/04

(52) U.S. Cl. 430/494

(57) ABSTRACT

The present invention provides a method of forming a digital images exhibiting superior clearness in line images and superior visual whiteness. An image forming method of the invention comprises exposing a silver halide photographic material and processing the photographic material, wherein the photographic material contains a compound represented by the following formula (1) and a white area of the processed photographic material exhibits perception chromaticity indexes a and b of from 0.0 to +2.0 and from −2.2 to −4.0, respectively, in which the foregoing a and b are defined in JIS-Z-8730 and measured in accordance with a method defined in JIS-Z-8722:

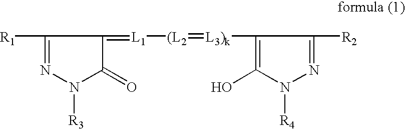

### TECHNICAL FIELD

The present invention relates to an image forming method of a silver halide photographic material and in particular to a silver halide photographic material exhibiting superior image quality in line images and an image forming method by use thereof.

### TECHNICAL BACKGROUND

There has been broadly used silver halide photographic light-sensitive material (hereinafter, also denoted simply as photographic material) on account of superior gradation and higher sensitivity. Silver halide photographic material is exposed and processed to form images and exposure is often performed by analog exposure via negative images but recently, performance of digital scanning exposure such as laser scanning exposure has also increased.

Specifically, an output method of digital image information is needed along with the recent progress of digital cameras and, for example, there are employed silver halide photographic materials and methods such as an ink-jet printer and a sublimation type printer. Of these, image formation onto silver halide photographic material using digital scanning exposure has the advantage that prints of high image quality can be inexpensively obtained in large quantities. Further, image formation through digital exposure has a merit that in addition to adjustment of image characteristics and image editing, composition of character images can be simply carried out.

However, when performing of image and text information in silver halide photographic material using digital exposure, problems arise in that text quality, specifically, sharpness of line images tends to be deteriorated. As is distinct from ink-jet imaging, image formation using silver halide material is often affected by characteristics of the silver halide and additives. In silver halide photographic material, sharpness can be improved by enhancement of gradation characteristics of the silver halide emulsion or by the use of colorant dyes, but improvement of clearness of line images was insufficient.

Accordingly, it is a first object of the present invention to provide a method for forming images with superior clearness of a line image from silver halide photographic material.

It is a second object of the invention to provide a method of forming an image exhibiting superior visual whiteness.

### DISCLOSURE OF THE INVENTION

The foregoing objects of the invention is accomplished by the following constitution:
(1) An image forming method comprising exposing and processing a silver halide photographic material, wherein the photographic material contains a compound represented by the following formula (1) and a white area of the processed photographic material exhibits perception chromaticity indexes a and b of from 0.0 to +2.0 and from −2.2 to −4.0, respectively, wherein the foregoing a and b are defined in JIS-Z-8730 and determined in accordance with a method defined in JIS-Z-8722: 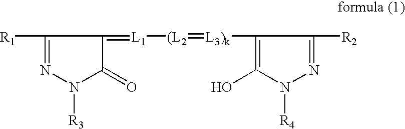
   wherein R₁ and R₂ are each —CN, —COOR or —CONR₇R₈; R₃ and R₄ are each a hydrogen atom, an alkyl group, a cycloalkyl group, an aryl group or a heterocyclic group; L₁, L₂ and L₃ are each a methine group and k is 2, provided that the respective —L₂=L₃—may be the same or different; R₅ and R₆ are each a hydrogen atom, an alkyl group or an aryl group; R₇ and R₈ are each a hydrogen atom, an alkyl group, an alkenyl group, an aryl group or a heterocyclic group or R₇ and R₈ may combine with an adjacent nitrogen atom to form a 5- or 6-membered ring, provided that R₇ and R₈ are not hydrogen atoms at the same time and at least one of R₁, R₂, R₃ and R₄ is a water-solubilizing group or a group containing a water-solubilizing group;
(2) An image forming method comprising exposing and processing a silver halide photographic material, wherein the photographic material is exposed by scanning exposure with a light beam and a white area of the photographic material exhibits perception chromaticity indexes a and b of from 0.0 to +2.0 and from −2.2 to −4.0, respectively, wherein the foregoing a and b are defined in JIS-Z-8730 and determined in accordance with a method defined in JIS-Z-8722;
(3) An image forming method comprising exposing and processing a silver halide photographic material, wherein the photographic material contains a compound represented by the foregoing formula (1), the photographic material is exposed by scanning exposure with a light beam and a white area of the processed photographic material exhibits perception chromaticity indexes a and b of from 0.0 to +2.0 and from −2.2 to −4.0, respectively, wherein the foregoing a and b are defined in JIS-Z-8730 and determined in accordance with a method defined in JIS-Z-8722;
(4) The image forming method as described in ay of the foregoing (1) to (3), wherein the total amount of gelatin contained in the photographic material is not more than 6.2 g/m²;
(5) The image forming method as described in any of the foregoing (1) to (4), wherein the photographic material contains a compound represented by the following formula (2): 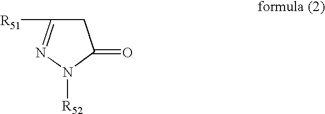
   wherein R₅₁ is a carbonamide group or an anilino group; R₅₂ is a phenyl group which may be substituted;
(6) The image forming method as described in ay of the foregoing (1) to (5), wherein the photographic material contains a compound represented by the following formula (3): 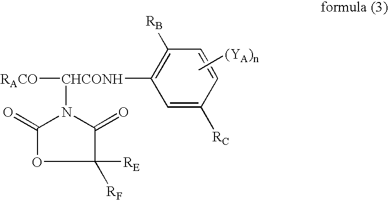
   wherein R_{A} is an alkyl group; R_{B} is a halogen atom or an alkoxy group; R_{C} is COOR_{D1}, —COOR_{D2}COOR_{D1}, —NHCOR_{D2}SO₂R_{D1}, —N(R_{D3})SO₂R_{D1} or —SO₂N(R_{D3})R_{D1}, in which R_{D1} is a univalent organic group, R_{D2} is an alkylene group and R_{D3} is an alkyl group, an aralkyl group or a hydrogen atom; YA is a univalent organic group; n is 0 or 1; RE and RF are each a hydrogen atom or an alkyl group;
(7) A silver halide photographic material, wherein the photographic material contains a compound represented by the foregoing formula (1) and a white area of the photographic material processed in standard process A exhibits perception chromaticity indexes a and b of from 0.0 to +2.0 and from −2.2 to −4.0, respectively, wherein the foregoing a and b are defined in JIS-Z-8730 and determined in accordance with a method defined in JIS-Z-8722;
(8) A silver halide photographic material, wherein the photographic material contains a compound represented by the foregoing formula (2) and a white area of the photographic material processed in standard process A exhibits perception chromaticity indexes a and b of from 0.0 to +2.0 and from −2.2 to −4.0, respectively, wherein the foregoing a and b are defined in JIS-Z-8730 and determined in accordance with a method defined in JIS-Z-8722; and
(9) A silver halide photographic material, wherein the photographic material contains a compound represented by the foregoing formula (3) and when processed in standard process A and measured in accordance with a measurement method defined in JIS-Z-8722, a white area of the photographic material exhibits perception chromaticity indexes a and b of from 0.0 to +2.0 and from −2.2 to −4.0, respectively, wherein the foregoing a and b are defined in JIS-Z-8730 and determined in accordance with a method defined in JIS-Z-8722.

### PREFERRED EMBODIMENTS OF THE INVENTION

The present invention has come into being as a result of extensive study of image forming methods to improve text clearness by using silver halide photographic materials, thus, it was discovered that when a silver halide photographic material comprising a specific constitution was processed and the white area of the processed photographic material exhibited perception chromaticity indexes a and b of from 0.0 to +2.0 and from −2.2 to −4.0, respectively which were measured in the method described in JIS-Z-8722 and defined in JIS-Z-8730, improved clearness of line images was achieved. Silver halide photographic materials often have usually performed image formation so that perception chromaticity indexes a and b fell in the range of from 0.0 to 2.0 and from +1.0 to −1.5, respectively, but allowing the perception chromaticity indexes a and b to fall in the range of from 0.0 to +2.0 and from −2.2 to −4.0 results in superior sharpness of line images.

Further, the use of a compound of formula (1), a compound of formula (2) or a compound of formula (3) is preferred in this invention. Furthermore, the total amount of gelatin contained in the silver halide photographic material preferably is not more than 6.0 g/m², and more preferably not more than 5.4 g/m².

Next, the present invention will be detailed. The perception chromaticity indexes a and b defined in this invention refer to lightness index L and perception chromaticity indexes a and b in CIE LAB (L*a*b* color system abbreviation recommended by Commission Internationale de 1 “Echairage”) and the details thereof are described in “Shinpen Shikisaikagaku Handbook” (edited by Nippon Shikisai-Gakkai) page 267, an item of CIE L*a*b*.

In this invention, the index a is from 0.0 to +2.0 and the index b is from −2.2 to −4.0, and a and b preferably from 0.0 to +1.5 and from −2.5 to −3.5, respectively; and more preferably from 0.3 to +1.5 and from −2.8 to −3.4.

Next, there will be described the compound represented by formula (1). The compound of formula (1) can be synthesized by allowing a dioxopyrazolopyridine compound to react with an appropriate monomethine source, trimethine source or pentamethine source compound. Specifically, the synthesis thereof can be conducted by using methods described in JP-B Nos. 39-22069, 43-3504, 52-38056, 54-38129 and 55-10059 (hereinafter, the term JP-B refers to Japanese Patent Publication); JP-A Nos. 49-99620 and 59-16834 (hereinafter, the term JP-A refers to Japanese Patent Application publication) and U.S. Pat. No. 4,181,225.

Next, the compound of formula (1) will be explained. Examples of an alkyl group represented by R₃ to R₈ include methyl, ethyl, isopropyl, butyl and t-butyl and the alkyl group may be substituted by a substituent such as hydroxy group, a sulfo group, carboxyl group, halogen atom (e.g., fluorine, chlorine, bromine, iodine)alkoxy group (e.g., methoxy, ethoxy), aryloxy group (e.g., phenoxy, 4-sulfophenoxy, 2,4-disulfophenoxy), aryl group (e.g., phenyl, 4-sulfophenyl, 2,5-disulfophenyl), cyano group, and alkoxycarbonyl group (e.g., methoxycarbonyl).

Examples of an aryl group represented by R₃ to R₈ include a phenyl group and a naphthyl group. The aryl group may be substituted. Such substituted phenyl groups include, for example, 2-methoxyphenyl, 4-nitrophenyl, 3-chlorophenyl, 4-cyanophenyl, 4-hydroxyphenyl, 4-methanesulfonylphenyl, 4-sulfophenyl. 3-sulfophenyl, 2-methyl-4-sulfophenyl, 2-chloro-4-sulfophenyl, 4-chloro3-sulfpphenyl, 2-chloro-5-sulfophenyl, 2-methoxy5-sulfophenyl, 2-hydroxy-4-sulfophenyl, 2,5-dichloro4-sulfophenyl, 2,6-diethyl-4-sulfophenyl, 2,5-disulfophenyl, 3,5-disulfophenyl, 2,4-disulfophenyl, 4-phenoxy-3-sulfophenyl, 2-chloro-6-methyl-4-sulfophenyl, 3carboxy2-hydroxy-5-sulfophenyl, 4-carboxyphenyl, 2,5-dicarboxyphenyl, 3,5-dicarboxyphenyl, 2,4-diacarboxyphenyl, 3,6-disulfo-α-naphthyl, 8-hydroxy-3,6-disulfo-α-naphthyl, 5-hydroxy-7-sulfo-β-naphthyl and 6,8-disulfo-β-naphthyl.

Examples of an alkenyl group represented by R₇ and R₈ include a vinyl group and allyl group, and the alkenyl group also includes a substituted one.

Examples of a heterocyclic group represented by R₃, R₄, R₇ and R₈ include a pyridyl group (e.g., 2-pyridyl, 3-pyridyl, 4-pyridyl, 5-sulfo-2-pyridyl, 5-carboxy-2-pyridyl, 3,5-dichloro-2-pyridyl, 4,6-dimethyl-2-pyridyl, 6-hydroxy-2-pyridyl, 2,3,5,6-tetrafluoro-4-pyridyl, 3-nitro-2-pyridyl), an oxazolyl group (e.g., 5-sulfo-2-benzoyloxazolyl, 2-benzooxazolyl, 2-oxazolyl), a thiazolyl group (e.g., 5-sulfo-2-benzothiazolyl, 2-benzothiazolyl, 2-thiazolyl), an imidazolyl group (e.g., 1-methyl-2-imidazolyl, 1-methyl-5-sulfo-2-benzoimidazolyl), a furyl group (e.g., 3-furyl), a pyrrolyl group (e.g., 3-pyrrolyl), a thienyl group (e.g., 2-thienyl), a pyrazinyl group (e.g., 2-pyrazinyl), a pyrimidinyl group (e.g., 2-pyrimidinyl, 4-chloro-2-pyrimidinyl), a pyridazinyl group (e.g., 2-pyridazinyl), a purinyl group (e.g., 8-purinyl), an isooxazolinyl group (e.g., 3-isooxazolylinyl), a selenazolyl group (e.g., 5-sulfo-2-selenazolyl9, a sulfolanyl group (e.g., 3-sulfolnyl), piperidinyl group (e.g., 1-methyl-2-piperidinyl), a pyrazolyl group (e.g., 3-pyrazolyl), and a tetrazolyl group (e.g., 1-tetrazolyl).

Examples of a cycloalkyl group represented by R₃ and R₄ include cyclopentyl and cyclohexyl and the cycloalkyl group may be substituted.

A methine group represented by L₁ to L₃ may be substituted by a substituent (e.g., an alkyl group, aryl group).

Examples of a 5- or 6-membered ring formed by combination of R₇ and R₈ together with a nitrogen atom include pyrrolidine piperazine, piperidine and morpholine.

At least one of R₁ to R₄ contains a water-solubilizing group and examples of such a water-solubilizing group include a sulfo group, a carboxyl group and a sulfolanyl group. The water-solubilizing group include its sodium and potassium salts.

Specific examples of the compound of formula (1) include compounds Nos. 1-1 to 1-32, described in JP-A No. 5-307239, pages 4-8. Of the compounds of formula (1), a preferred compound is one in which R₁ and R₂ are each an alkylcarbonyl group or an alkoxycarbonyl group (preferably alkylcarbonyl group). Specific examples of a more preferred compound include, for example, compound No. 1-7 described in the foregoing disclosure.

To display further effects of the invention, the silver halide photographic material of the invention contains a four-equivalent 5-pyrazolone magenta coupler, specifically, a four-equivalent 5-pyralone magenta coupler represented by the foregoing formula (2).

Next, there will be described compounds of formula (2). In formula (2), R₅₁ represents a carbonamide group or an anilino group; R₅₂ represents a phenyl group which may be substituted. Of couplers of formula (2), one containing a carbonamide group is preferred. The coupler may be a polymeric coupler. Four-equivalent 5-pyrazolone magenta couplers known in the art are usable in this invention. Specific examples thereof include four-equivalent magenta couplers (M−1) to (M-38), as described in JP-B No. 5-8415, pages 12-21.

Next, a compound represented by formula (3) will be further described in detail. In formula (3), an alkyl group represented by RA is a straight or branched alkyl group and includes, for example, methyl, ethyl, I-propyl, t-butyl, dodecyl, 1-hexylnonyl, cyclopropyl, cyclohexyl and admantyl. The alkyl group may be substituted and examples of a substituent include a halogen atom (e.g., chlorine atom, bromine atom), an aryl group (e.g., phenyl, p-t-octylphenyl9, an alkoxy group (e.g., methoxy), an aryloxy group (e.g., 2,4-di-t-pentylphenoxy), a sulfonyl group (e.g., methanesulfonyl), an acyl group (e.g., acetyl, benzoyl), a sulfonylamino group (e.g., dodecanesulfonylamino), and hydroxyl. R_{A} preferably is a branched alkyl group and more preferably t-butyl.

An alkoxy group represented by R_{B} is a straight or branched alkoxy group and examples of such a straight or branched alkoxyl group include methoxy, ethoxy, 1-methylethyloxy, tobutyloxy, dodecyloxy and 1-hexylnonyloxy. Of these, methoxy is preferred. A halogen atom represented by RB is, for example, a chlorine atom, bromine atom or fluorine atom, and preferably a chlorine atom.

In COOR_{D1}, —COOR_{D2}COOR_{D1}, —NHCOR_{D2}SO₂R_{D1}, —N (R_{D3}) SO₂R_{D1} and —SO₂N(R_{D3})R_{D1} represented by R_{C}, a univalent organic group represented by R_{D1} preferably is a group having a function as a diffusion-proof, for example, a straight or branched alkyl group having at least 10 carbon atoms (such as dodecyl or octadecyl) or an aryl group (such as 2,4-dipentylphenyl), and more preferably a straight or branched alkyl group having at least 14 carbon atoms. An alkylene group represented by R_{D2} is preferably, for example, a propylene or trimethylene group. An alkyl group represented by R_{D3} is preferably a straight or branched one, for example, methyl, ethyl or i-propyl, and an aralkyl group is preferably, for example, benzyl. R_{C} preferably is —COOR_{D1}.

An alkyl group represented by RE and RF is a straight or branched alkyl group having 1 to 10 carbon atoms, for example, methyl, ethyl, propyl, i-propyl, butyl or hexyl, and of these, methyl is specifically preferred.

Examples of a univalent organic group represented by Y_{A} include an alkyl group (e.g., ethyl, i-propyl, t-butyl), an alkoxy group (e.g., methoxy), an aryloxy group (e.g., phenyloxy), an acyloxy group (e.g., methylcarbonyloxy, benzoyloxy), an acylamino group (e.g., acetoamide, phenylcarbonylamino), a carbamoyl group (e.g., N-methylcarbamoyl, N-phenylcarbamoyl), an alkylsulfonylamino group (e.g., ethylsulfonylamino), an arylsulfonylamino (e.g., phenylsulfonylamino), a sulfamoyl group (e.g., N-propylsulfamoyl, N-phenylsulfamoyl) and an imido group (e.g., succinic acid imido, glutarimido).

Yellow forming couplers represented by formula (3) can be synthesized by conventional methods known to the art. There may be used at least two compounds of formula (3) or a compound of formula (3) in combination with other couplers.

In this invention, a coating amount of a yellow forming coupler within a silver halide photographic material is preferably 0.50×10⁻³ to 1.10×10⁻³ mol/m², and more preferably 0.60×40⁻³ to 1.00×10⁻³ mol/m². The coating amount of a yellow forming coupler refers to the total amount of all yellow forming couplers, not the content of a compound of formula (3) alone.

Of the foregoing compounds of formula (3), a compound containing a R_{C} having an ester linkage group is preferred. Specific examples of the compound of formula (3) include compounds I-1 to I-23 described in paragraph Nos. (0047)-(0048) of JP-A No. 10-142756.

Next, scanning exposure by using a light beam related to this invention will be described.

In this invention, scanning exposure by using a light beam is usually conducted by combination of linear exposure by using a light beam (luster exposure: main scanning) and the relative movement (sub-scanning) of photographic material in the direction perpendicular to the direction of linear exposure. There are employed many systems, including, for example, a system (drum system) in which photographic material is fixed on the outer or inner periphery of a cylindrical drum and main scanning is carried out by irradiating a light beam with rotating the drum, while sub-scanning is simultaneously carried out by moving a light source in the direction perpendicular to the direction of rotation of the drum; and a system (polygon system) in which a light beam is irradiated onto a rotating polygon mirror and the reflected light beam is scanned in the direction horizontal to the direction of rotation of the polygon mirror (to perform main scanning), while transporting a photographic material vertically to the direction of rotation of the drum to perform sub-scanning. Further, in the case of using an exposure apparatus in which light sources are arranged in an array-form at a width more than that of the photographic material, the main scanning is typically replaced by an array-form light source, which is applicable to the scanning exposure usable in this invention.

Most light sources known in the art are usable in this invention and include, for example, a light-emitting diode (LED), a gas laser, a semiconductor laser (LD), and a combination of an LD or a solid laser using LD as the exciting light and a second harmonic generating element (a so-called SHG element).

One preferred embodiment of this invention is an image forming method comprised of exposing and processing a silver halide photographic material, in which the photographic material is exposed by scanning exposure with a light beam and the photographic material contains at least one of a compound represented by the afore-mentioned formula (1), a compound represented by the afore-mentioned formula (2) or a compound represented by the afore-mentioned formula (3), and the white area of the processed photographic material exhibits perception chromaticity indexes a and b of from 0.0 to +2.0 and from −2.2 to −4.0, respectively, which are defined in JIS-Z-8730 and measured in accordance with a measurement method defined in JIS-Z-8722.

Next, the total coating amount of gelatin will be described. The total amount of gelatin contained in the photographic material preferably is not more than 6.2 g/m², and more preferably not more than 5.7 g/m².

Next, standard process A relating to this invention will be described. The standard process A represents photographic processing being run using automatic processor NPS-868J, product by Konica Corp. and processing chemicals ECOJET-P, in accordance with process CPK-2-J1.

Constituent elements usable in the photographic material of this invention, other than those described above, can employ compounds described in JP-A No. 11-347615, page 9, line 22, paragraph No. 0044 to page 14, line 17, paragraph No. 0106, including, for example, a silver halide emulsion, emulsion additives, a sensitization method, an antifoggant, a stabilize, an antiirradiation dye, a fluorescent brightener, a yellow coupler, a magenta coupler, a cyan coupler, a spectrally sensitizing dye, a emulsion-dispersing method, a surfactant, an antistaining agent, a binder, a hardener, a lubricant or matting agent, a support, a blueing or red-shifting agent, a coating method, an exposure method, a color developing agent, a processing method, a processing apparatus and processing chemicals.

Next, the present invention will be described based on examples but embodiments of the invention are by no means limited to these.

### EXAMPLE 1

### Preparation of Sample 101

There was prepared a paper support laminated, on paper with a weight of 180 g/m², with high density polyethylene, provided that the side to be coated with an emulsion layer was laminated with polyethylene melt containing surface-treated anatase type titanium oxide in an amount of 15% by weight. The reflection support was subjected to corona discharge and provided with a gelatin sublayer, and further thereon, the following component layers were provided to prepare a silver halide photographic material sample 101. There were used hardeners H-1 and H-2, and an antiseptic agent F-1.

Constitution of Sample 101:

| | g/m² |
|---|---|
| 7th Layer (Protective layer) | |
| Gelatin | 1.00 |
| DBP | 0.002 |
| DIDP | 0.002 |
| Silicon dioxide | 0.003 |
| 6th Layer (UV absorbing layer) | |
| Gelatin | 0.40 |
| UV absorbent (UV-1) | 0.084 |
| UV absorbent (UV-2) | 0.027 |
| UV absorbent (UV-3) | 0.114 |
| Antistaining agent (HQ-5) | 0.04 |
| PVP | 0.03 |
| 5th Layer (Red-sensitive layer) | |
| Gelatin | 1.30 |
| Red-sensitive emulsion (Em-R) | 0.21 |
| Cyan coupler (C-1) | 0.25 |
| Cyan coupler (C-2) | 0.08 |
| Dye image stabilizer (ST-1) | 0.10 |
| Antistaining agent (HQ-1) | 0.004 |
| DBP | 0.10 |
| DOP | 0.20 |
| 4th Layer (UV absorbing layer) | |
| Gelatin | 0.94 |
| UV absorbent (UV-1) | 0.196 |
| UV absorbent (UV-2) | 0.063 |
| UV absorbent (UV-3) | 0.266 |
| Antistaining agent (HQ-5) | 0.10 |
| 3rd Layer (Green-sensitive layer) | |
| Gelatin | 1.30 |
| AI-2 | 0.01 |
| Green-sensitive Emulsion (Em-G) | 0.14 |
| Magenta coupler (MI-1) | 0.20 |
| Dye image stabilizer (ST-3) | 0.20 |
| Dye image stabilizer (ST-4) | 0.17 |
| DIDP | 0.13 |
| DBP | 0.13 |
| 2nd Layer (Interlayer) | |
| Gelatin | 1.20 |
| AI-3 | 0.01 |
| Antistaining agent (HQ-2) | 0.03 |
| Antistaining agent (HQ-3) | 0.03 |
| Antistaining agent (HQ-4) | 0.05 |
| Antistaining agent (HQ-5) | 0.23 |
| DIDP | 0.04 |
| DBP | 0.02 |
| Brightener (W-1) | 0.10 |
| 1st Layer (Blue-sensitive layer) | |
| Gelatin | 1.20 |
| Blue-sensitive Emulsion (Em-B) | 0.26 |
| Yellow coupler (Y-1) | 0.70 |
| Dye image stabilizer (ST-1) | 0.10 |
| Dye image stabilizer (ST-2) | 0.10 |
| Antistaining agent (HQ-1) | 0.01 |
| Image stabilizer (ST-5) | 0.10 |
| Image stabilizer B | 0.15 |
| DNP | 0.05 |
| DBF | 0.15 |

Support
Polyethylene-laminated paper containing a slight amount of colorant

The amount of silver halide was represented by equivalent converted to silver. Additives used in sample 101 are as follows.
DBP: Dibutyl phthalate
DNP: Dinonyl phthalate
DOP: Dioctyl phthalate
DIDP: Diisodecyl phthalate
PVP: Polyvinylpyrrolidone
H-1: Tetrakis(vinylsulfonylmethyl)methane
H-2: 2,4-Dichloro-6-hydroxy-s-triazine sodium salt
HQ-1: 2,5-Di-t-octylhydroquinone
HQ-2: 2,5-Di-sec-dodecylhydroquinone
HQ-3: 2,5-Di-sec-tetradecylhydroquinone
HQ-4: 2-sec-Dodecyl-5-sec-tetradecylhydoquinone
HQ-5: 2,5-Di(1,1-dimethyl-4-hexyloxycarbonyl)-butylhydroqinone
Image stabilizer A: p-t-Octylphenol 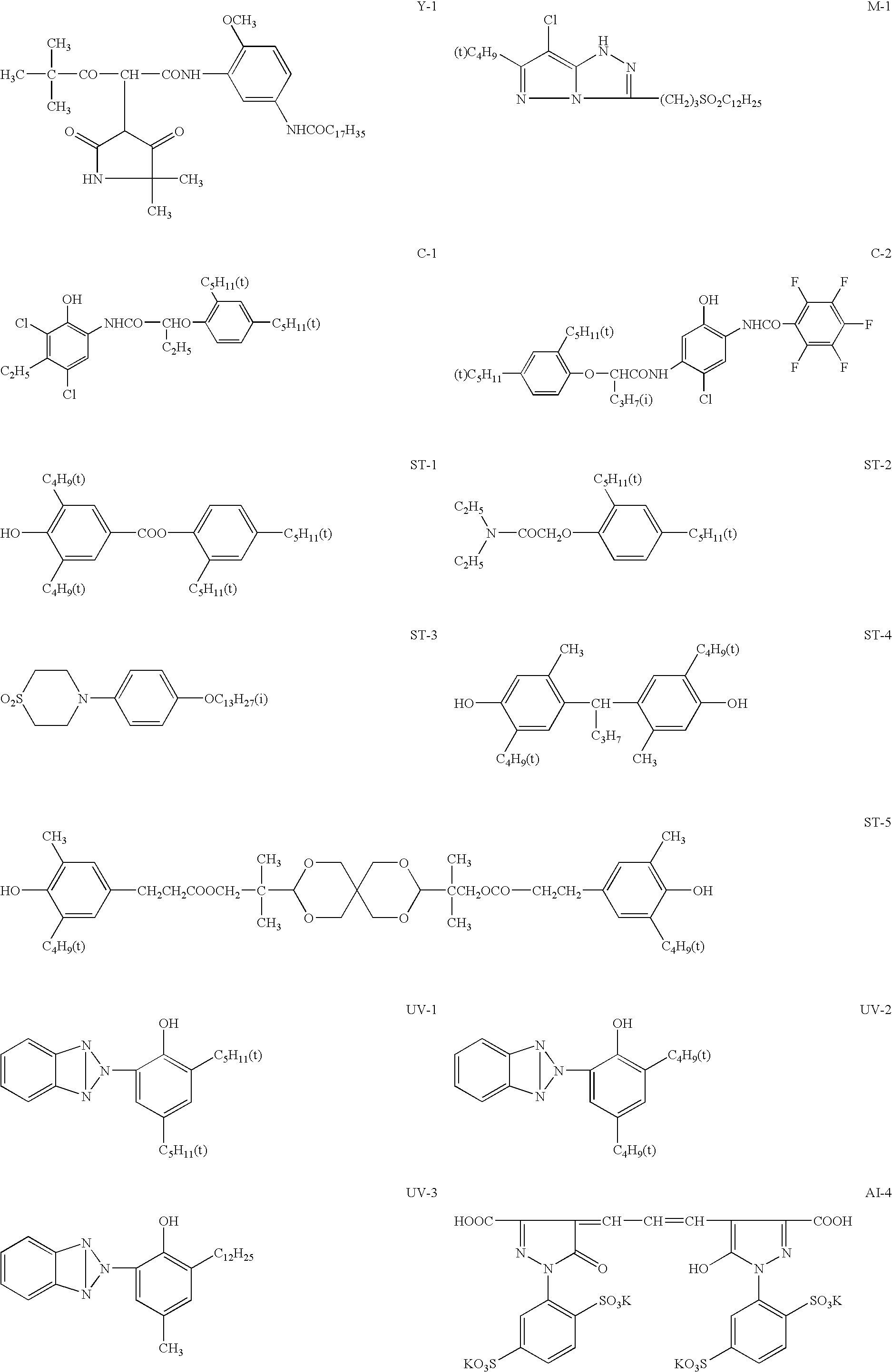 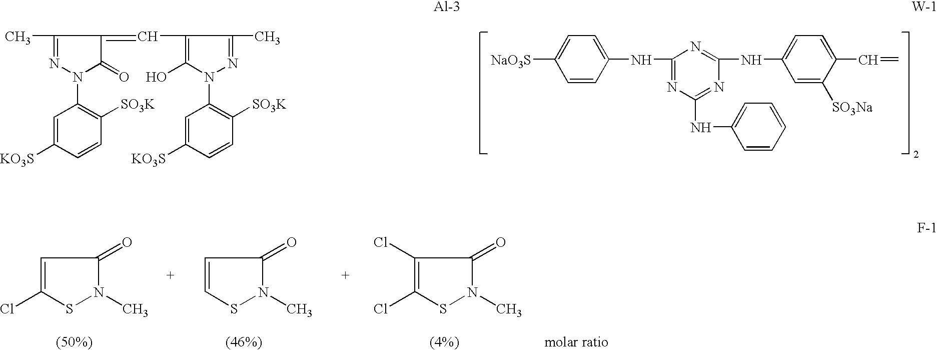
   Preparation of Blue-Sensitive Silver Halide Emulsion

To 1 liter of aqueous 2% gelatin solution kept at 40° C. were simultaneously added the following solutions (A) and (B) over a period of 30 min., while being maintained at a pAg of 7.3 and pH of 3.0, and further thereto were added solutions (C) and (D) for a period of 180 min., while being maintained at a pAg of 8.0 and pH of 5.5. The pAg was controlled according to the method described in JP-A No. 59-45437 and the pH was controlled using aqueous sulfuric acid or sodium hydroxide solution.

Solution A

| | | |
|---|---|---|
| Sodium chloride | 3.42 | g |
| Potassium bromide | 0.03 | g |
| Water to make | 200 | ml |

Solution B

| | | |
|---|---|---|
| Silver nitrate | 10 | g |
| Water to make | 200 | ml |

Solution C

| | | |
|---|---|---|
| Sodium chloride | 102.7 | g |
| K₂IrCl₆ | 4 × 10⁻⁸ | mol/mol Ag |
| K₄Fe(CN)₆ | 2 × 10⁻⁵ | mol/mol Ag |
| Potassium bromide | 1.0 | g |
| Water to make | 600 | ml |

Solution D

| | | |
|---|---|---|
| Silver nitrate | 300 | g |
| Water to make | 600 | ml |

After completing the addition, the resulting emulsion was desalted using a 5% aqueous solution of Demol N (produced by Kao-Atlas) and aqueous 20% magnesium sulfate solution, and re-dispersed in a gelatin aqueous solution to obtain a monodisperse cubic grain emulsion (EMP-1) having an average grain size of 0.71 μm, a coefficient of variation of grain size of 0.07 and a chloride content of 99.5 mol %. Monodisperse cubic grain emulsions, EMP-1B having an average grain size of 0.64 μm, a coefficient of variation of grain size of 0.07 and a chloride content of 99.5 mol % was prepared similarly to EMP-1, provided that the addition time of Solutions A and B and the addition time of Solutions C and D were respectively varied.

The thus obtained emulsion, EMP-1 was chemically sensitized at 60° C. using the following compounds. Similarly, emulsion EMP-1B was chemically sensitized. These emulsions EMP-1 and EMP-1B were blended in a ratio of 1:1 to obtain a blue-sensitive silver halide emulsion (Em-B).

| | | |
|---|---|---|
| Sodium thiosulfate | 0.8 | mg/mol AgX |
| Chloroauric acid | 0.5 | mg/mol AgX |
| Stabilizer STAB-1 | 3 × 10⁻⁴ | mol/mol AgX |
| Stabilizer STAB-2 | 3 × 10⁻⁴ | mol/mol AgX |
| Stabilizer STAB-3 | 3 × 10⁻⁴ | mol/mol AgX |
| Sensitizing dye BS-1 | 4 × 10⁻⁴ | mol/mol AgX |
| Sensitizing dye BS-2 | 1 × 10⁻⁴ | mol/mol AgX |

Preparation of Green-Sensitive Silver Halide Emulsion

Monodisperse cubic grain emulsion, EMP-2 having an average grain size of 0.40 μm, a coefficient of variation of grain size of 0.08 and a chloride content of 99.5 mol % was prepared similarly to EMP-1, provided that the addition time of Solutions A and B and the addition time of Solutions C and D were respectively varied. Monodisperse cubic grain emulsion, EMP-2B having an average grain size of 0.50 μm, a coefficient of variation of grain size of 0.08 and a chloride content of 99.5 mol % was prepared similarly to EMP-1, provided that the addition time of Solutions A and B and the addition time of Solutions C and D were respectively varied.

The thus obtained emulsion, EMP-2 was chemically sensitized at 55° C. using the following compounds. Similarly, emulsion EMP-2B was chemically sensitized. These emulsions EMP-2 and EMP-2B were blended in a ratio of 1:1 to obtain a blue-sensitive silver halide emulsion (Em-G).

| | | |
|---|---|---|
| Sodium thiosulfate | 1.5 | mg/mol AgX |
| Chloroauric acid | 1.0 | mg/mol AgX |
| Stabilizer STAB-1 | 3 × 10⁻⁴ | mol/mol AgX |
| Stabilizer STAB-2 | 3 × 10⁻⁴ | mol/mol AgX |
| Stabilizer STAB-3 | 3 × 10⁻⁴ | mol/mol AgX |
| Sensitizing dye GS-1 | 4 × 10⁻⁴ | mol/mol AgX |

Preparation of Red-Sensitive Silver Halide Emulsion

Monodisperse cubic grain emulsions, EMP-3 having an average grain size of 0.40 μm, a coefficient of variation of grain size of 0.08 and a chloride content of 99.5 mol % was prepared similarly to EMP-1, provided that the addition time of Solutions A and B and the addition time of Solutions C and D were respectively varied. Monodisperse cubic grain emulsions, EMP-3B having an average grain size of 0.38 μm, a coefficient of variation of grain size of 0.08 and a chloride content of 99.5 mol % was prepared similarly.

The thus obtained emulsion, EMP-3 was chemically sensitized at 60° C. using the following compounds. Similarly, emulsion EMP-3B was chemically sensitized. These emulsions EMP-3 and EMP-3B were blended in a ratio of 1:1 to obtain a red-sensitive silver halide emulsion (Em-R).

| | | |
|---|---|---|
| Sodium thiosulfate | 1.8 | mg/mol AgX |
| Chloroauric acid | 2.0 | mg/mol AgX |
| Stabilizer STAB-1 | 3 × 10⁻⁴ | mol/mol AgX |
| Stabilizer STAB-2 | 3 × 10⁻⁴ | mol/mol AgX |
| Stabilizer STAB-3 | 3 × 10⁻⁴ | mol/mol AgX |
| Sensitizing dye RS-1 | 1 × 10⁻⁴ | mol/mol AgX |
| Sensitizing dye RS-2 | 1 × 10⁻⁴ | mol/mol AgX |

Stablizer STAB-1: 1-(3-acetoamidophenyl)-5-mercaptotetrazole
Stabilizer STAB-2: 1-phenyl-5-mercaptotetrazole
Stabilizer STAB-3: 1-(4-ethoxyphenyl)-5-mercaptotetrazole

To the red-sensitive emulsion, SS-1 was added in an amount of 2.0×10⁻³ mol per mol of silver halide.

Additives used in the preparation of the respective color sensitive emulsions are shown below.

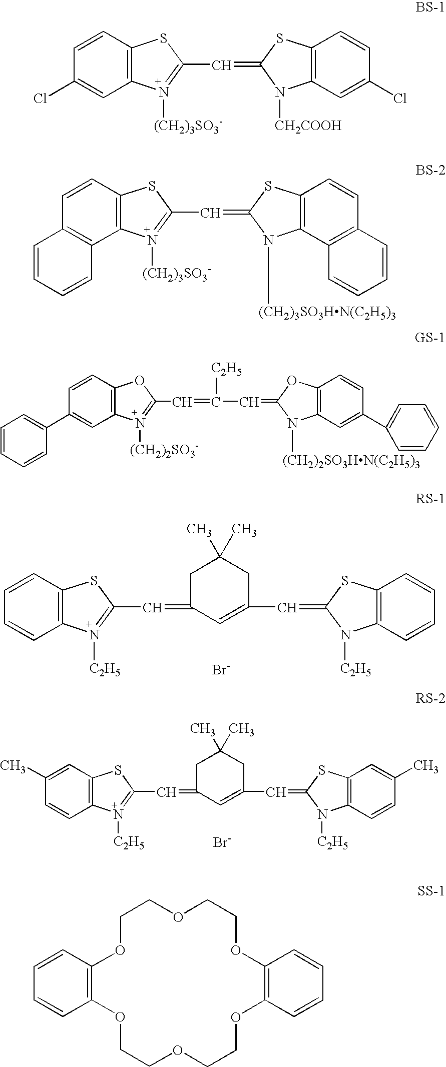

The thus prepared sample was denoted as Sample 101.

### Preparation of Samples 102 to 111

Samples 102 to 111 were prepared similarly to the foregoing sample 101, provided that perception chromaticity indexes a and b were optimally adjusted by varying the content of fluorescent brightener (W-1) used in the 2nd layer and by using a small amount of a colorant, a compound of formula (1) was used at 0.03 g/m² in the 5th layer and contents of gelatin used in the respective layers were varied in the same ratio, as shown below.

### Preparation of Sample 112

Sample 112 was prepared similarly to sample 111, provided that a magenta coupler was replaced by MC-1 and the coating amount of silver was doubled in the 3rd layer.

### Preparation of Sample 113

Sample 113 was prepared similarly to sample 112, provided that the yellow coupler used in the 1st layer was replaced by YC-1.

Details of the thus prepared samples 101 to 113 are shown below.

| | | | |
|---|---|---|---|
| | Compound | Chromaticity | Gelatin |
| Sample | of | Index | Content |

| No. | Formula (1) | a | b | (g/m²) | Remark |
|---|---|---|---|---|---|
| 101 | — | 1.1 | −1.5 | 7.34 | Comp. |
| 102 | — | 0.9 | −2.8 | 7.34 | Inv. |
| 103 | AI-1 | −0.1 | −4.2 | 7.34 | Comp. |
| 104 | AI-1 | 1.1 | −1.5 | 7.34 | Comp. |
| 105 | AI-1 | 0.9 | −2.9 | 7.34 | Inv. |
| 106 | AI-1 | 0.8 | −2.6 | 7.34 | Inv. |
| 107 | AI-1 | 0.7 | −2.4 | 7.34 | Inv. |
| 108 | AI-1 | −0.3 | −4.6 | 7.34 | Comp. |
| 109 | AI-2 | 0.9 | −3.0 | 7.34 | Inv. |
| 110 | AI-2 | 0.9 | −3.0 | 6.12 | Inv. |
| 111 | AI-2 | 0.9 | −3.0 | 5.65 | Inv. |
| 112 | AI-2 | 0.9 | −3.0 | 5.64 | Inv. |
| 113 | AI-2 | 0.9 | −3.0 | 5.62 | Inv. |

Further, AI-1, AI-2, MC-1 and YC-1 are shown below.

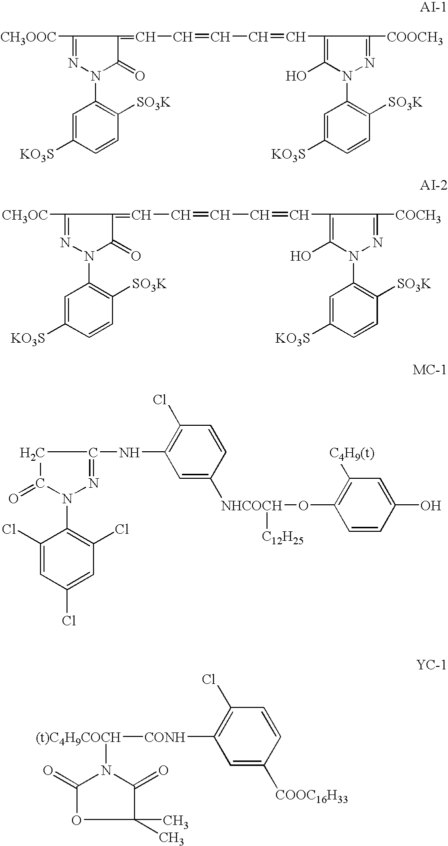

### Evaluation of Samples

The prepared samples were subjected to scanning exposure and processed as follows. Scanning exposure was conducted in the manner that using light sources of a semiconductor laser (oscillation wavelength: 650 nm), He—Ne gas laser (oscillation wavelength: 544 nm) and Ar gas laser (oscillation wavelength: 458 nm), the individual laser beams were modulated, based on image data, by AOM with respect to light quantity and allowed to be reflected by a polygon mirror, and main scanning was performed onto photographic material, simultaneously while transporting the photographic material in the direction perpendicular to the main scanning (to perform sub-scanning). The beam diameter was confirmed to be 100 μm for each of RGB, using a beam monitor.

Then, processing was carried out according to the following steps to prepare lettered color prints.

Process

| Processsing Step | Temperature | Time | Repl. Amt.* | |
|---|---|---|---|---|
| Color developing | 38.0 ± 0.3° C. | 45 sec. | 80 | ml |
| Bleach-fixing | 35.0 ± 0.5° C. | 45 sec. | 120 | ml |
| Stabilizing | 30-34° C. | 60 sec. | 150 | ml |
| Drying | 60-80° C. | 30 sec. | | |

*Replenishing amount

Composition of processing solution is shown below.

Color developer (Tank solution, Replenisher)

| | Tank soln. | | Replenisher | |
|---|---|---|---|---|
| Water | 800 | ml | 800 | ml |
| Trithylenediamine | 2 | g | 3 | g |
| Diethlene glycol | 10 | g | 10 | g |
| Potassium bromide | 0.01 | g | — | |
| Potassium cloride | 3.5 | g | — | |
| Potassium sulfite | 0.25 | g | 0.5 | g |
| N-ethyl-N(β-methanesulfonamidoethyl)- | 6.0 | g | 10.0 | g |
| 3-methyl-4-aminoaniline sulfate | | | | |
| N,N-diethlhydroxyamine | 6.8 | g | 6.0 | g |
| Triethanolamine | 10.0 | g | 10.0 | g |
| Sodium diethyltriaminepentaacetate | 2.0 | g | 2.0 | g |
| Brightener (4,4′-dimenostilbene- | 2.0 | g | 2.5 | g |
| disulfonate derivative) | | | | |
| Potassium carbonate | 30 | g | 30 | g |

Water is added to make 1 liter, and the pH of the tank solution and replenisher were respectively adjusted to 10.10 and 10.60 with sulfuric acid or potassium hydroxide.

Bleach-fixer (Tank solution, Replenisher)

| | | |
|---|---|---|
| Diethylenetriaminepentaacetic acid | 65 | g |
| iron (III) ammonium salt dihydrate | | |
| Diethylenetriaminepentaacetic acid | 3 | g |
| Ammonium thiosulfate (70% aqueous solution) | 100 | ml |
| 2-Amino-5-mercapto-1,3,4-thiadiazole | 2.0 | g |
| Ammonium sulfite (40% aqueous solution) | 27.5 | ml |

Water is added to make 1 liter, and the pH is adjusted to 5.0.

Stabilizer (Tank solution, Replenisher)

| | | |
|---|---|---|
| o-Phenylphenol | 1.0 | g |
| 5-Chloro-2-methyl-4-isothiazoline-3-one | 0.02 | g |
| 2-Methyl-4-isothiazoline-3-one | 0.02 | g |
| Diethylene glycol | 1.0 | g |
| Brightener (Chinopal SFP) | 2.0 | g |
| 1-Hydroxyethylidene-1,1-diphosphonic acid | 1.8 | g |
| Bismuth chloride (45% aqueous solution) | 0.65 | g |
| Magnesium sulfate hepta-hydrate | 0.2 | g |
| Polyvinyl pyrrolidone | 1.0 | g |
| Ammonia water (25% aqueous | 2.5 | g |
| ammonium hydroxide solution) | | |
| Trisodium nitrilotriacetate | 1.5 | g |

Water is added to make 1 liter, and the pH is adjusted to 7.5 with sulfuric acid or ammonia water.

The thus obtained samples were visually observed by ten observers with respect to clearness of lettered images and evaluated based on the following criteria of ten ranks, and the average point was made a measure of lettered image clearness:
1: discrimination between image and letter being insufficient,
5: image and letter being able to discriminate,
10: image and letter being clearly discriminated.

The ranks other than the foregoing were set by equally dividing the foregoing ranks.

Further, the samples were also visually observed by ten observers with respect to whiteness of the white background and evaluated based on the following criteria to determine the average rank:
A: white background of extremely preferred whiteness,
B: white background of preferred whiteness,
C: tone of white background being slightly distinct from white,
D: tone of white background being apparently distinct from white and being incompatible.

Evaluation results are shown below.

| Sample | clearness of | | |
|---|---|---|---|
| No. | Lettered Image | Whiteness | Remark |
| 101 | 4.1 | D | Comp. |
| 102 | 4.0 | A | Inv. |
| 103 | 3.9 | D | Comp. |
| 104 | 5.5 | C | Comp. |
| 105 | 7.6 | A | Inv. |
| 106 | 7.4 | A | Inv. |
| 107 | 7.2 | B | Inv. |
| 108 | 5.6 | D | Comp. |
| 109 | 7.9 | A | Inv. |
| 110 | 8.1 | A | Inv. |
| 111 | 8.4 | A | Inv. |
| 112 | 8.6 | A | Inv. |
| 113 | 8.7 | A | Inv. |

### EXAMPLE 2

Samples were processed similarly to Example 1, provided that processing was run using automatic processor NPS-8681J and processing chemicals ECOJET-P, available from Konica Corp. in accordance with process CPK-2-J1. As a result of evaluation similar to Example 1, it was proved that samples of the invention were superior in lettered image clearness and whiteness to comparative samples.

### INDUSTRIAL APPLICABILITY

An image forming method using a silver halide photographic material relating to the invention has provided a method for displaying images superior in clearness of lettered and whiteness.

1. An image forming method comprising:
exposing a silver halide photographic material and
processing the photographic material,
wherein the photographic material contains a compound represented by the following formula (1) and a white area of the processed photographic material exhibits perception chromaticity indexes a and b of from 0.0 to +2.0 and from −2.2 to −4.0, respectively, wherein said a and b are defined in JIS-Z-8730 and measured in accordance with a method defined in JIS-Z-8722: 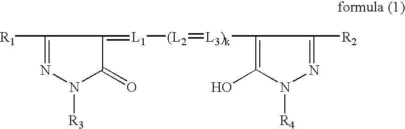
wherein R₁ and R₂ are each —CN, —COOR or —CONR₇R₈; R₃ and R₄ are each a hydrogen atom, an alkyl group, a cycloalkyl group, an aryl group or a heterocyclic group; L₁, L₂ and L₃ are each a methine group and k is 2, provided that the respective—L₂=L₃—may be the same or different; R₅ and R₆ are each a hydrogen atom, an alkyl group or an aryl group; R₇ and R₈ are each a hydrogen atom, an alkyl group, an alkenyl group, an aryl group or a heterocyclic group or R₇ and R₈ may combine with an adjacent nitrogen atom to form a 5- or 6-membered ring, provided that R₇ and R₈ are not hydrogen atoms at the same time and at least one of R₁, R₂, R₃ and R₄ is a water-solubilizing group or a group containing a water-solubilizing group.

2. An image forming method comprising:
exposing a silver halide photographic material and
processing the photographic material,
wherein the photographic material is exposed by scanning exposure with a light beam and a white area of the photographic material exhibits perception chromaticity indexes a and b of from 0.0 to +2.0 and from −2.2 to −4.0, respectively, wherein said a and b are defined in JIS-Z-8730 and measured in accordance with a method defined in JIS-Z-8722.

3. An image forming method comprising:
exposing a silver halide photographic material and
processing the photographic material,
wherein the photographic material contains a compound represented by formula (1) as claimed in claim 1, the photographic material is exposed by scanning exposure with a light beam and a white area of the processed photographic material exhibits perception chromaticity indexes a and b of from 0.0 to +2.0 and from −2.2 to −4.0, respectively, wherein said a and b are defined in JIS-Z-8730 and measured in accordance with a method defined in JIS-Z-8722.

4. The image forming method as claimed in claim 1, wherein the total amount of gelatin contained in the photographic material is not more than 6.2 g/m².

5. The image forming method as claimed in claim 1, wherein the photographic material contains a compound represented by the following formula (2): 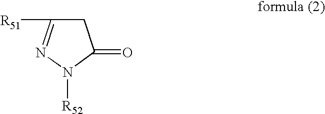
wherein R₅₁ is a carbonamide group or an anilino group; R₅₂ is a phenyl group which may be substituted.

6. The image forming method as claimed in claim 1, wherein the photographic material contains a compound represented by the following formula (3): 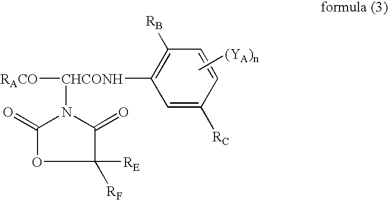
wherein R_{A} is an alkyl group; R_{B} is a halogen atom or an alkoxy group; R_{C} is COOR_{D1}, —COOR_{D2}COOR_{D1}, —NHCOR_{D2}SO₂R_{D1}, —N(R_{D3})SO₂R_{D1} or —SO₂N(R_{D3})R_{D1}, in which R_{D1} is a univalent organic group, R_{D2} is an alkylene group and R_{D3} is an alkyl group, an aralkyl group or a hydrogen atom; Y_{A} is a univalent organic group; n is 0 or 1; R_{E} and R_{F} are each a hydrogen atom or an alkyl group.

7. A silver halide photographic material, wherein the photographic material contains a compound represented by formula (1) as claimed in claim 1 and a white area of the photographic material processed in standard process A exhibits perception chromaticity indexes a and b of from 0.0 to +2.0 and from −2.2 to −4.0, respectively, wherein said a and b are defined in JIS-Z-8730 and measured in accordance with a method defined in JIS-Z-8722.

8. A silver halide photographic material, wherein the photographic material contains a compound represented by formula (2) as claimed in claim 5 and a white area of the photographic material processed in standard process A exhibits perception chromaticity indexes a and b of from 0.0 to +2.0 and from −2.2 to −4.0, respectively, wherein said a and b are defined in JIS-Z-8730 and measured in accordance with a method defined in JIS-Z-8722.

9. A silver halide photographic material, wherein the photographic material contains a compound represented by formula (3) as claimed in claim 6 and a white area of the photographic material processed in standard process A exhibits perception chromaticity indexes a and b of from 0.0 to +2.0 and from −2.2 to −4.0, respectively, wherein said a and b are defined in JIS-Z-8730 and measured in accordance with a method defined in JIS-Z-8722.

10. The image forming method of claim 2, wherein the total amount of gelatin contained in the photographic material is not more than 6.2 g/m².

11. The image forming method of claim 2, wherein the photographic material contains a compound represented by the following formula (1): 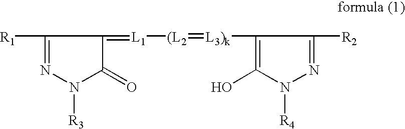
wherein R₁ and R₂ are each —CN, —COOR or —CONR₇R₈; R₃ and R₄ are each a hydrogen atom, an alkyl group, a cycloalkyl group, an aryl group or a heterocyclic group; L₁, L₂ and L₃ are each a methine group and k is 2, provided that the respective—L₂=L₃—may be the same or different; R₅ and R₆ are each a hydrogen atom, an alkyl group or an aryl group; R₇ and R₈ are each a hydrogen atom, an alkyl group, an alkenyl group, an aryl group or a heterocyclic group or R₇ and R₈ may combine with an adjacent nitrogen atom to form a 5- or 6-membered ring, provided that R7 and R8 are not hydrogen atoms at the same time and at least one of R₁, R₂, R₃ and R₄ is a water-solubilizing group or a group containing a water-solubilizing group.

12. The image forming method of claim 2, wherein the photographic material contains a compound represented by the following formula (2): 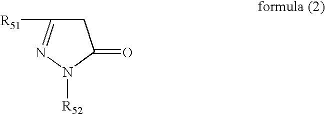
wherein R₅₁ is a carbonamide group or an anilino group; R₅₂ is a phenyl group which may be substituted.

13. The image forming method of claim 2, wherein the photographic material contains a compound represented by the following formula (3): 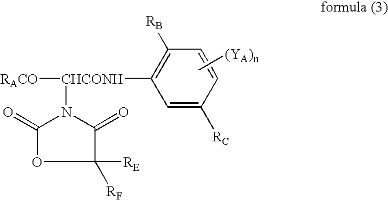
wherein R_{A} is an alkyl group; R_{B} is a halogen atom or an alkoxy group; R_{C} is COOR_{D1}, —COOR_{D2}COOR_{D1}′-NHCOR_{D2}SO₂R_{D1}, —N(R_{D3})SO₂R_{D1} or —SO₂N(R_{D3})R_{D1}, in which R_{D1} is a univalent organic group, R_{D2} is an alkylene group and R_{D3} is an alkyl group, an aralkyl group or a hydrogen atom; Y_{A} is a univalent organic group; n is 0 or 1; R_{E} and R_{F} are each a hydrogen atom or an alkyl group.

14. The image forming method of claim 3, wherein the total amount of gelatin contained in the photographic material is not more than 6.2 g/m².

15. The image forming method of claim 3, wherein the photographic material contains a compound represented by the following formula (2): 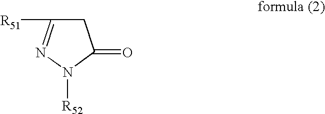
wherein R₅₁ is a carbonamide group or an anilino group; R₅₂ is a phenyl group which may be substituted.

16. The image forming method of claim 3, wherein the photographic material contains a compound represented by the following formula (3): 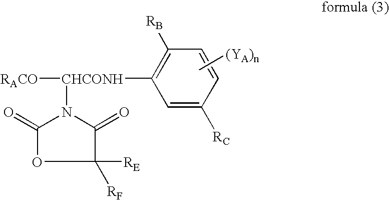
wherein R_{A} is an alkyl group; R_{B} is a halogen atom or an alkoxy group; R_{C} is COOR_{D1}, —COOR_{D2}COOR_{D1}, —NHCOR_{D2}SO₂R_{D1}, —N(R_{D3})SO₂R_{D1} or —SO₂N(R_{D3})R_{D1}, in which R_{D1} is a univalent organic group, R_{D2} is an alkylene group and R_{D3} is an alkyl group, an aralkyl group or a hydrogen atom; Y_{A} is a univalent organic group; n is 0 or 1; R_{E} and R_{F} are each a hydrogen atom or an alkyl group.
